(19) United States
(12) Patent Application Publication
(10) Pub. No.: US 2026/0264395 A1
(43) Pub. Date: Sep. 10, 2026

(54) INK VOLUME ANALYSIS APPARATUS

(71) Applicant: Samsung Display Co., LTD., Yongin-si (KR)

(72) Inventors: Satoshi TOMOEDA, Yongin-si (KR); Do Hyeong KIM, Yongin-si (KR); Hyun Kyu AHN, Yongin-si (KR); Chan Sung JUNG, Yongin-si (KR); Myung Soo HUH, Yongin-si (KR)

(21) Appl. No.: 19/411,296

(22) Filed: Dec. 7, 2025

(30) Foreign Application Priority Data
Mar. 4, 2025 (KR) 10-2025-0027647
Jun. 26, 2025 (KR) 10-2025-0085057

(51) Int. Cl. B41J 2/045

(52) U.S. Cl. CPC B41J 2/04535; B41J 2/0456; B41J 2/04561; B41J 2/04586

(57) ABSTRACT

An ink volume analysis apparatus includes a camera which images an ink ejected from a nozzle of an inkjet head, and an analyzer which analyzes an imaging result provided by the camera and analyzes a volume of the ink based on a result associated with analyzing the imaging result, wherein the analyzer divides the imaging result provided by the camera into a plurality of areas and analyzes a total volume of the ink based on respective volumes of unit ink portions respectively corresponding to the plurality of areas.

This application claims priority to Korean Patent Application No. 10-2025-0027647, filed on Mar. 4, 2025, and Korean Patent Application No. 10-2025-0085057, filed on Jun. 26, 2025, and all the benefits accruing therefrom under 35 U.S.C. § 119, the contents of which in their entirety are herein incorporated by reference.

### BACKGROUND

### Field

The present disclosure relates to an ink volume analysis apparatus.

### Description of Related Art

Inkjet printing technology is widely used in various industrial fields such as printing, electronic circuit manufacturing, and bioprinting that may call for high resolution and precision. In such inkjet printing technology, it is important to accurately measure a volume of ink ejected from a nozzle in order to maintain a constant quality. When the volume of the ink ejected from the nozzle is not constant, problems such as deterioration of output quality, printing defects, and nozzle clogging may occur.

### SUMMARY

A purpose of the present disclosure is to provide an ink volume analysis apparatus capable of precisely analyzing a volume of inks ejected from a plurality of nozzles.

The volume of the ink ejected from a nozzle may be measured using an ink volume analysis apparatus. The ink volume analysis apparatus may image the ink ejected from the nozzle with a camera, and analyze the imaging result to measure the volume of the ejected ink.

The technical purposes of the present disclosure are not limited to the above-mentioned technical purposes, and other technical purposes not mentioned may be clearly understood by a person skilled in the art of the present disclosure from the following description.

According to an aspect of the present disclosure, an ink volume analysis apparatus includes a camera which images an ink ejected from a nozzle of an inkjet head, and an analyzer which analyzes an imaging result provided by the camera and analyzes a volume of the ink based on the analyzing result, wherein the analyzer divides the imaging result provided by the camera into a plurality of areas and analyzes a total volume of the ink based on respective volumes of unit ink portions respectively corresponding to the plurality of areas.

For each of the unit ink portions respectively corresponding to the plurality of areas, the analyzer analyzes a diameter and a vertical length of the unit ink portion and analyzes the volume of the unit ink portion based on the diameter and the vertical length of the unit ink portion.

The analyzer analyzes the volume of the unit ink portion using a following Equation 1:

$$V = π \times {( \frac{R}{2} )}^{2} \times S H \qquad < Equation 1 >$$

where V denotes the volume of the unit ink portion, R denotes the diameter of the unit ink portion, SH denotes the vertical length of the unit ink portion.

The analyzer calculates a sum of the respective volumes of the unit ink portions corresponding to the plurality of areas and calculates the total volume of the ink based on the sum.

The analyzer divides the imaging result provided by the camera into the plurality of areas, and each of the plurality of areas extends in a direction intersecting a direction in which the ink is ejected.

The camera is spaced apart from the nozzle in a direction in which the ink is ejected.

A spacing between the camera and the nozzle ranges from 50 mm to 300 mm.

The nozzle includes a plurality of nozzles, the plurality of nozzles are arranged in a direction and are disposed on a lower surface of the inkjet head, and the ink volume analysis apparatus further includes a moving module which moves the camera in the direction in which the nozzles are arranged.

The moving module includes a guide rail disposed under the inkjet head and extending in the direction, wherein the guide rail guides a movement path of the camera, and a driver which moves the camera along the guide rail.

The ink volume analysis apparatus further includes a controller which controls the moving module in association with controlling movement of the camera.

The controller calculates a movement speed of the camera based on a spacing between adjacent nozzles of the plurality of nozzles and an ejection frequency of the ink as respectively ejected from the adjacent nozzles, and controls the driver in association with moving the camera according to the calculated movement speed.

The controller calculates the movement speed of the camera using a following Equation 2:

$$MV = W \times F \qquad < Equation 2 >$$

where MV denotes the movement speed of the camera, W denotes the spacing between the adjacent nozzles of the plurality of nozzles, and F denotes the ejection frequency of the ink from one or more of the plurality of nozzles.

The camera further images the plurality of nozzles of the inkjet head, wherein the controller receives an imaging result of the plurality of nozzles and the ink as respectively ejected from the plurality of nozzles from the camera and detects the spacing between the adjacent nozzles and the ejection frequency of the ink, based on the received imaging result.

According to an aspect of the present disclosure, an ink volume analysis apparatus includes a camera which images an ink respectively ejected from a plurality of nozzles of an inkjet head, a moving module which moves the camera in a direction in which the plurality of nozzles are arranged, and a controller which controls the moving module in association with controlling movement of the camera, wherein the controller: calculates a movement speed of the camera based on a spacing between adjacent nozzles of the plurality of nozzles and an ejection frequency of the ink as respectively ejected from the adjacent nozzles, and controls the moving module in association with moving the camera according to the calculated movement speed.

The moving module includes a guide rail disposed under the inkjet head and extending in a direction in which the nozzles are arranged, wherein the guide rail guides a movement path of the camera, and a driver which moves the camera along the guide rail.

The camera further images the plurality of nozzles of the inkjet head, wherein the controller receives an imaging result of the plurality of nozzles and the ink as respectively ejected from the plurality of nozzles from the camera and detects the spacing between the adjacent nozzles and an ejection frequency of the ink based on the received imaging result.

The ink volume analysis apparatus further includes an analyzer which analyzes an imaging result provided by the camera and calculates a volume of the ink based on the imaging result, wherein the analyzer divides the imaging result provided by the camera into a plurality of areas and analyzes a total volume of the ink based on respective volumes of unit ink portions respectively corresponding to the plurality of areas.

For each of the unit ink portions respectively corresponding to the plurality of areas, the analyzer analyzes a diameter and a vertical length of the unit ink portion and analyzes the volume of the unit ink portion based on the diameter and the vertical length of the unit ink portion.

The analyzer calculates a sum of respective volumes of the unit ink portions corresponding to the plurality of areas and calculates the total volume of the ink based on the sum.

The analyzer divides the imaging result provided by the camera into the plurality of areas, and each of the plurality of areas extends in a direction intersecting a direction in which the ink is ejected.

According to the ink volume analysis apparatus of the present disclosure, the camera images the inks respectively ejected from the plurality of nozzles while the camera is moving in a direction in which the plurality of nozzles are arranged, and the analyzer analyzes the imaging result provided by the camera to analyze the volume of the inks, such that the volume of the inks respectively ejected from the plurality of nozzles may be precisely analyzed.

The effects according to the embodiments of the present disclosure are not limited to those mentioned above and more various effects are included in the following description of the present disclosure.

### BRIEF DESCRIPTION OF DRAWINGS

The above and other aspects and features of the present disclosure will become more apparent by illustrating in detail embodiments thereof with reference to the attached drawings, in which:

FIG. 1 is a diagram schematically illustrating an ink volume analysis apparatus according to an embodiment of the present disclosure;

FIG. 2 is a diagram illustrating a state in which FIG. 1 is viewed in a first direction;

FIG. 3 is an enlarged view of a portion A of FIG. 1;

FIG. 4 is an enlarged view of a portion B of FIG. 2;

FIG. 5 is a diagram illustrating a state in which a camera images ink ejected from a nozzle;

FIG. 6 is a block diagram illustrating a connection relationship between the camera, a driver, a controller, and an analyzer of FIG. 1;

FIG. 7 is a diagram illustrating a state in which an imaging result of a camera is divided into a plurality of areas;

FIG. 8 is an enlarged view of a portion C of FIG. 7; and

FIG. 9 is a perspective view of an unit ink portion of FIG. 8.

### DETAILED DESCRIPTIONS

Advantages and features of the present disclosure and methods to achieve them will become apparent from the descriptions of example embodiments hereinbelow with reference to the accompanying drawings. However, the present disclosure is not limited to example embodiments disclosed herein but may be implemented in various different ways. The example embodiments are provided for making the disclosure of the present disclosure thorough and for fully conveying the scope of the present disclosure to those skilled in the art. It is to be noted that the scope of the present disclosure is defined only by the claims.

As used herein, a phrase “an element A on an element B” refers to that the element A may be disposed directly on the element B and/or the element A may be disposed indirectly on the element B via another element C. Like reference numerals denote like elements throughout the descriptions. The figures, dimensions, ratios, angles, numbers of elements given in the drawings are illustrative and are not limiting.

Although terms such as first, second, and the like are used to distinguish arbitrarily between the elements such terms describe, and thus these terms are not necessarily intended to indicate temporal or other prioritization of such elements. These terms are used to merely distinguish one element from another. Accordingly, as used herein, a first element may be a second element within the technical scope of the present disclosure.

Features of various example embodiments of the present disclosure may be combined partially or totally. As will be clearly appreciated by those skilled in the art, technically various interactions and operations are possible. Various example embodiments can be practiced individually or in combination.

Hereinafter, example embodiments of the present disclosure will be described in detail with reference to the accompanying drawings.

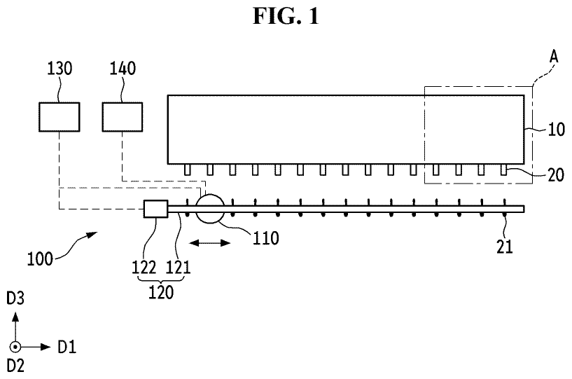

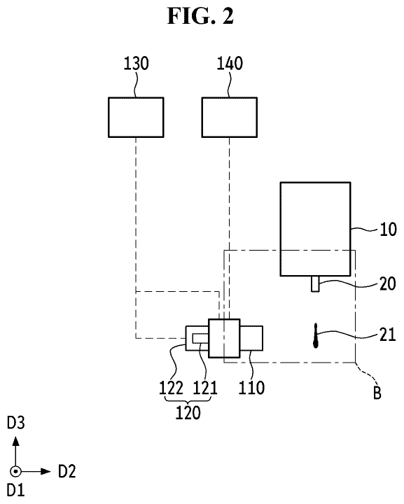

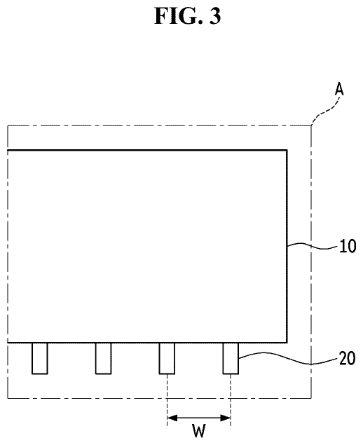

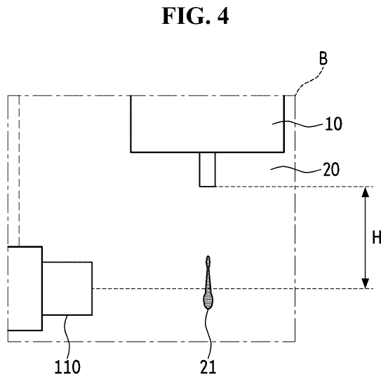

FIG. 1 is a diagram schematically illustrating an ink volume analysis apparatus according to an embodiment of the present disclosure. FIG. 2 is a diagram illustrating a state in which FIG. 1 is viewed in a first direction. FIG. 3 is an enlarged view of a portion A of FIG. 1. FIG. 4 is an enlarged view of a portion B of FIG. 2.

Referring to FIGS. 1 to 4, an ink volume analysis apparatus 100 according to an embodiment of the present disclosure may be disposed in an inkjet printing apparatus (not illustrated) and may be configured to analyze the volume of the inks 21 respectively ejected from a plurality of nozzles 20 of an inkjet head 10. The plurality of nozzles 20 may be disposed on a lower surface of the inkjet head 10 and be arranged so as to be spaced apart from each other by a predetermined distance W along a first direction D1. The ink volume analysis apparatus 100 may include a camera 110, a moving module 120, a controller 130, and an analyzer 140.

The camera 110 may image the inks 21 respectively ejected from the nozzles 20 of the inkjet head 10. In some aspects, the camera 110 may image the plurality of nozzles 20. The camera 110 may be disposed under the nozzles 20 so as not to overlap the inkjet head 10. For example, the camera 110 may be disposed under the nozzle 20 in a third direction D3 and may be disposed to be spaced apart from the inkjet head 10 by a predetermined vertical length H in the third direction D2. A spacing by which the camera 110 is spaced apart from the nozzles 20 may range from 50 mm to 300 mm. The camera 110 may image the inks 210 respectively ejected from the nozzles 20 and transmit the imaging result to the controller 130 and the analyzer 140.

The moving module 120 may move the camera 110 in a direction in which the nozzles 20 are arranged. In some embodiments, the moving module 120 may move the camera 110 along the first direction D1. The moving module 120 may include a guide rail 121 and a driver 122.

The guide rail 121 may guide a movement path of the camera 110. The guide rail 121 may be disposed under the nozzles 20 so as not to overlap the inkjet head 10. The guide rail 121 may extend in the first direction D1. The guide rail 121 may extend longer than the length in which the nozzles 20 are arranged. The camera 110 may be disposed on the guide rail 121 and may be moved in the first direction D1 along the guide rail 121.

The driver 122 may be connected to the camera 110 and be configured to move the camera 110 along the guide rail 121. The driver 122 may be provided as a linear motor that generates a linear driving force. The driver 122 may operate under the control of the controller 130.

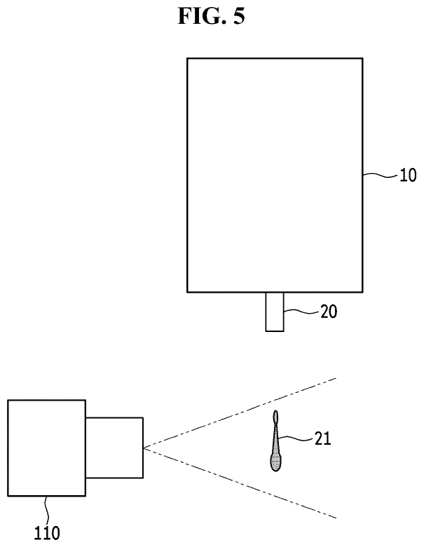

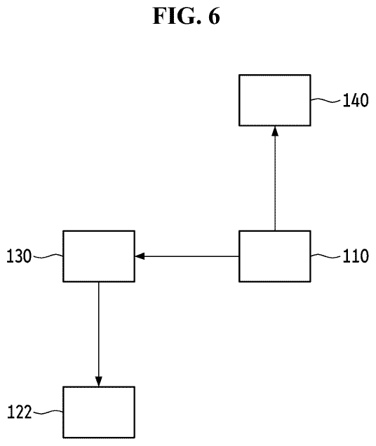

FIG. 5 is a diagram illustrating a state in which a camera images the ink (i.e. captures images of the ink) ejected from a nozzle. FIG. 6 is a block diagram illustrating a connection relationship between a camera, a driver, a controller, and an analyzer of FIG. 1.

Referring further to FIGS. 5 and 6, the controller 130 may control the moving module 120 to control the movement of the camera 110. The controller 130 may receive, from the camera 110, the imaging result of the nozzles 20 and the inks 21 respectively ejected from the nozzles 20, and sense the spacing W between the nozzles 20 and an ejection frequency of the ink 21.

The controller 130 may calculate a movement speed of the camera 110 based on the spacing W between adjacent nozzles 20 of the plurality of nozzles 20 and the ejection frequency of the ink 21 respectively ejected from the nozzles 20, and may control the driver 122 in association with moving the camera 110 according to the calculated movement speed.

Descriptions herein of adjacent nozzles 20 may refer to nozzles 20 which follow one another in order in a given direction (e.g., the first direction DR1, or the direction opposite the first direction DR1), without a further nozzle 20 in between.

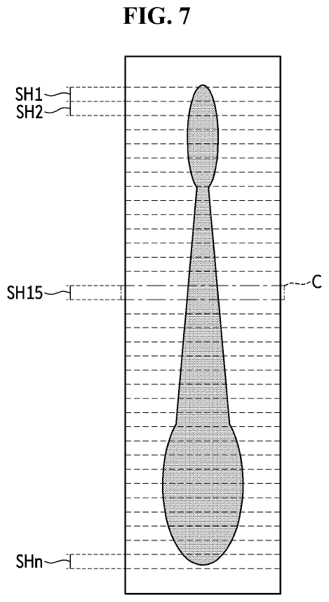

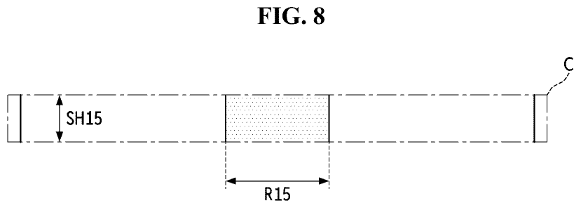

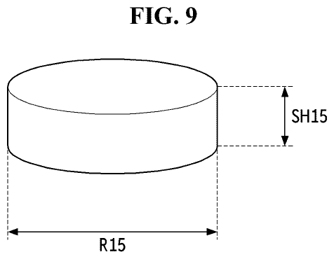

FIG. 7 is a diagram illustrating a state in which an imaging result of a camera is divided into a plurality of areas. The imaging result may be, for example, an image captured by the camera. FIG. 8 is an enlarged view of a portion C of FIG. 7. FIG. 9 is a perspective view of an unit ink portion of FIG. 8.

Referring further to FIGS. 7 to 9, the analyzer 140 may receive and analyze the imaging result provided by the camera 110 and may analyze the volume of the inks 21 respectively ejected from the nozzles 20, based on the analysis result. The analyzer 140 may divide the imaging result provided by the camera 110 into a plurality of areas, and analyze a total volume of the inks 21 based on the volume of the unit ink portion in each of the areas.

The analyzer 140 may divide the imaging result provided by the camera 110 into the plurality of areas. Division lines for dividing the imaging result provided by the camera 110 into the plurality of areas may extend in a direction orthogonal to the direction in which the ink 21 is ejected. The division lines may be spaced apart from each other by a predetermined vertical length SH along the third direction D3. The ink 21 may be divided into a plurality of unit ink portions via the plurality of division lines. For example, a vertical length of the uppermost unit ink portion of FIG. 7 may be SH1, and a vertical length of the lowermost unit ink portion of FIG. 7 may be SHn. The vertical lengths of all unit ink portions from the uppermost unit ink portion of FIG. 7 to the lowermost unit ink portion of FIG. 7 may be equal to each other. The vertical length of each unit ink portion may be 1 pixel.

The analyzer 140 may detect and analyze a diameter and the vertical length of the unit ink portion in each of the areas, and analyze the volume of the unit ink portion based on the diameter and vertical length of each unit ink portion. For example, the analyzer 140 may analyze an image of a 15th unit ink portion from the uppermost end of FIG. 7 and recognize a diameter R15 and a vertical length SH15 of the 15th unit ink portion. The analyzer 140 may analyze the volume of the unit ink portion based on a following Equation 1:

$$V = π \times {( \frac{R}{2} )}^{2} \times S H \qquad < Equation 1 >$$

where V may be the volume of the unit ink portion, R may be the diameter of the unit ink portion, and SH may be the vertical length of the unit ink portion.

Under the above-described Equation 1, all of a volume V1 of the uppermost unit ink portion of FIG. 7 to a volume Vn of the lowermost unit ink portion of FIG. 7 may be obtained. After all of the volume V1 of the uppermost unit ink portion of FIG. 7 to the volume Vn of the lowermost unit ink portion of FIG. 7 are obtained, a total volume of the ink 21 may be calculated by summing all of the respective volumes of the unit ink portions.

In a state in which the camera 110 is imaging the inks 21 respectively ejected from the nozzles 20, the controller 130 may control the driver 122 in association with moving the camera 110 in the first direction D1. The controller 130 may set a movement speed of the camera 110 based on the spacing W between adjacent nozzles 20 of the plurality of nozzles 20 and the ejection frequency of the inks 21 respectively ejected from the nozzles 20. The controller 130 may define the movement speed of the camera 110 based on a following Equation 2:

$$MV = W \times F \qquad < Equation 2 >$$

where MV may be a movement speed of the camera, W may be the spacing between the nozzles, and F may be the ejection frequency of the ink from one or more of the adjacent nozzles.

The controller 130 may recognize the spacing between the nozzles 20 and the ejection frequency of the ink 21 based on the imaging result provided by the camera 110. The controller 130 may apply the recognized spacing between the nozzles 20 and ejection frequency of the ink 21 to the above Equation 2 to calculate the movement speed of the camera 110. In an example in which the spacing W between the nozzles 20 is 500 m and the ejection frequency F of the ink 21 is 1 kHz, the movement speed of the camera 110 may be calculated as 500 mm/sec. The controller 130 may control the driver 122 in association with moving the camera 110 according to the calculated movement speed of the camera 110.

Since the camera 110 is moved based on the spacing W between the nozzles 20 and the ejection frequency F of the ink 21, the images of the inks 21 ejected from all the nozzles 20 may be obtained under one time movement of the camera without stopping the camera 110. For example, the camera 110 may obtain an image of the ink 21 first ejected from a first nozzle 20, may obtain an image of the ink 21 second ejected from a second nozzle 20, and may obtain an image of the ink 21 last ejected from an N-th nozzle 20. As described herein, the images of the inks 21 ejected from all the nozzles 20 may be obtained under one time movement of the camera 110.

In the present embodiment, an example in which the camera 110 is moved based on the spacing W between adjacent nozzles 20 of the plurality of nozzles 20 and the ejection frequency of the inks 21 respectively ejected from the nozzles 20 is described. However, embodiments of the present disclosure are not limited thereto. For example, the camera 110 may be stationary, and the inkjet head 10 may be moved based on the spacing W between adjacent nozzles 20 of the plurality of nozzles 20 and the ejection frequency of the inks 21 respectively ejected from the nozzles 20. In this case, the camera 110 may be stationary, and the moving module 120 may move the inkjet head 10 in a direction in which the nozzles 20 are arranged. The guide rail 121 of the moving module 120 may guide a movement path of the inkjet head 10, and the driver 122 of the moving module 120 may move the inkjet head 10 along the guide rail 121. The controller 130 may set the movement speed of the inkjet head 10 based on the spacing W between adjacent nozzles 20 of the plurality of nozzles 20 and the ejection frequency of the inks 21 respectively ejected from the nozzles 20, and may control the driver 122 in association with moving the inkjet head 10 according to the set movement speed.

It should be understood, however, that the aspects and features of embodiments of the present disclosure are not restricted to the one set forth herein. The above and other aspects of the present disclosure will become more apparent to one of ordinary skill in the art to which the present disclosure pertains by referencing the claims, with equivalents thereof to be included therein.

What is claimed is:

1. An ink volume analysis apparatus comprising:
a camera which images an ink ejected from a nozzle of an inkjet head; and
an analyzer which analyzes an imaging result provided by the camera and analyzes a volume of the ink based on a result associated with analyzing the imaging result,
wherein the analyzer:
divides the imaging result provided by the camera into a plurality of areas, and
analyzes a total volume of the ink based on respective volumes of unit ink portions respectively corresponding to the plurality of areas.

2. The ink volume analysis apparatus of claim 1, wherein for each of the unit ink portions respectively corresponding to the plurality of areas, the analyzer:
analyzes a diameter and a vertical length of the unit ink portion, and
analyzes the volume of the unit ink portion based on the diameter and the vertical length of the unit ink portion.

3. The ink volume analysis apparatus of claim 2, wherein the analyzer analyzes the volume of the unit ink portion using a following Equation 1:
$$V = π \times {( \frac{R}{2} )}^{2} \times SH . \qquad < Equation 1 >$$
where V denotes the volume of the unit ink portion,
R denotes the diameter of the unit ink portion,
SH denotes the vertical length of the unit ink portion.

4. The ink volume analysis apparatus of claim 2, wherein the analyzer calculates a sum of the respective volumes of the unit ink portions corresponding to the plurality of areas and calculates the total volume of the ink based on the sum.

5. The ink volume analysis apparatus of claim 1, wherein the analyzer divides the imaging result provided by the camera into the plurality of areas, and each of the plurality of areas extends in a direction intersecting a direction in which the ink is ejected.

6. The ink volume analysis apparatus of claim 1, wherein the camera is spaced apart from the nozzle in a direction in which the ink is ejected.

7. The ink volume analysis apparatus of claim 6, wherein a spacing between the camera and the nozzle ranges from 50 mm to 300 mm.

8. The ink volume analysis apparatus of claim 1, wherein:
the nozzle comprises a plurality of nozzles,
the plurality of nozzles are arranged in a direction and are disposed on a lower surface of the inkjet head, and
the ink volume analysis apparatus further comprises a moving module which moves the camera in the direction in which the nozzles are arranged.

9. The ink volume analysis apparatus of claim 8, wherein the moving module comprises:
a guide rail disposed under the inkjet head and extending in the direction, wherein the guide rail guides a movement path of the camera; and
a driver which moves the camera along the guide rail.

10. The ink volume analysis apparatus of claim 9, further comprising a controller which controls the moving module in association with controlling movement of the camera.

11. The ink volume analysis apparatus of claim 10, wherein the controller:
calculates a movement speed of the camera based on:
a spacing between adjacent nozzles of the plurality of nozzles; and
an ejection frequency of the ink as respectively ejected from the adjacent nozzles; and
controls the driver in association with moving the camera according to the calculated movement speed.

12. The ink volume analysis apparatus of claim 11, wherein the controller calculates the movement speed of the camera using a following Equation 2:
$$MV = W \times F , \qquad < Equation 2 >$$
where MV denotes the movement speed of the camera,
W denotes the spacing between the adjacent nozzles of the plurality of nozzles, and
F denotes the ejection frequency of the ink from one or more of the plurality of nozzles.

13. The ink volume analysis apparatus of claim 11, wherein:
the camera further images the plurality of nozzles of the inkjet head, and
the controller receives an imaging result of the plurality of nozzles and the ink as respectively ejected from the plurality of nozzles from the camera and detects the spacing between the adjacent nozzles and the ejection frequency of the ink, based on the received imaging result.

14. An ink volume analysis apparatus comprising:
a camera which images an ink respectively ejected from a plurality of nozzles of an inkjet head;
a moving module which moves the camera in a direction in which the plurality of nozzles are arranged; and
a controller which controls the moving module in association with controlling movement of the camera,
wherein the controller:
calculates a movement speed of the camera based on a spacing between adjacent nozzles of the plurality of nozzles and an ejection frequency of the ink as respectively ejected from the adjacent nozzles; and
controls the moving module in association with moving the camera according to the calculated movement speed.

15. The ink volume analysis apparatus of claim 14, wherein the moving module comprises:
a guide rail disposed under the inkjet head and extending in a direction in which the nozzles are arranged, wherein the guide rail guides a movement path of the camera; and
a driver which moves the camera along the guide rail.

16. The ink volume analysis apparatus of claim 14, wherein:
the camera further images the plurality of nozzles of the inkjet head, and
the controller receives an imaging result of the plurality of nozzles and the ink as respectively ejected from the plurality of nozzles from the camera and detects the spacing between the adjacent nozzles and an ejection frequency of the ink based on the received imaging result.

17. The ink volume analysis apparatus of claim 14, further comprising an analyzer which analyzes an imaging result provided by the camera and calculates a volume of the ink based on the imaging result,
wherein the analyzer:
divides the imaging result provided by the camera into a plurality of areas, and
analyzes a total volume of the ink based on respective volumes of unit ink portions respectively corresponding to the plurality of areas.

18. The ink volume analysis apparatus of claim 17, wherein for each of the unit ink portions respectively corresponding to the plurality of areas, the analyzer:
analyzes a diameter and a vertical length of the unit ink portion, and
analyzes the volume of the unit ink portion based on the diameter and the vertical length of the unit ink portion.

19. The ink volume analysis apparatus of claim 18, wherein the analyzer calculates a sum of respective volumes of the unit ink portions corresponding to the plurality of areas and calculates the total volume of the ink based on the sum.

20. The ink volume analysis apparatus of claim 17, wherein the analyzer divides the imaging result provided by the camera into the plurality of areas, and each of the plurality of areas extends in a direction intersecting a direction in which the ink is ejected.
